(19) United States
(12) Patent Application Publication
(10) Pub. No.: US 2002/0119816 A1
(43) Pub. Date: Aug. 29, 2002

(54) Gambling game

(76) Inventor: David Aubrey Jackson, Sherman Oaks, CA (US)

Correspondence Address: DAVID AUBREY JACKSON, 14947 DICKENS ST. #1, SHERMAN OAKS, CA, 91403, US

(21) Appl. No.: 10/084,549

(22) Filed: Feb. 25, 2002

Related U.S. Application Data
(60) Provisional application No. 60/270,898, filed on Feb. 26, 2001.

(51) Int. Cl. A63F 13/00

(52) U.S. Cl. 463/16; 463/22

(57) ABSTRACT

A method and apparatus for a game of chance and odds by alternate participation of opposing players rolling a die and moving its game piece, the number of spaces designated by the die, toward opponent on a path. During game play, players attempt to position its game piece near, without landing on or going beyond, opposition's game piece to force opponent to forfeit. A player is awarded points when opponent forfeits or opponent's game piece lands on or goes beyond a player's game piece. A player may also be awarded points if its game piece lands in the anterior adjacent space of opponent's game piece. After points are awarded, players reposition its game pieces at the opposite ends of the path and game play is repeated until a player has accumulated the required number of points to win.

### BACKGROUND OF THE INVENTION

1. Field of the Invention

The present invention relates to a gambling game and more particularly, pertains to a new path apparatus and method of play that combines chance and odds for providing entertainment.

2. Description of the Prior Art

There are numerous games that have been provided in the prior art that are adapted to be played with skill and are also games of chance. However, the present invention substantially departs from the conventional concepts and designs of the prior art, and in so doing provides a method and apparatus primarily developed for entertainment as hereinafter described.

### BRIEF SUMMARY OF THE INVENTION

The present invention is directed to a path apparatus and method of play to allow two opposing players to devise a strategy and to be able to chance to win. While combining luck and odds in the game so as to allow any player to compete at the same time and maintain its interest and being simple enough to allow young and old players to play each other and enjoy the game.

To attain this, the present invention comprises a six-sided die, two game pieces representing each player, two score markers representing each player's score, a score path and a singular path having a first and second end, having defined thereon a plurality of spaces. Each space on the path will accommodate a single game piece to indicate a player's position. The game pieces are moved along the path of play towards its opposition according to the number rolled on the die. The game piece starting positions are located at opposite ends of the path. The singular pathway may be of any shape, size or length. The score path may be of any shape, size or length. The game apparatus may also be made of any type of rigid or semi-rigid material of any thickness.

The method of playing the game can be accomplished by using the path apparatus, or alternatively the method of playing the game can be incorporated into a computer program so that the game can be played using a computer display, keyboard and mouse.

There has thus been outlined the features of the invention in order that the detailed description thereof that follows may be better understood, and in order that the present contribution to the art may be better appreciated.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The present invention will be better understood and will become apparent when consideration is given to the following detailed description thereof. Such description makes reference to the annexed drawings wherein:

FIG. 1 is a drawing of the present invention and its components.

FIG. 2 is a drawing of an alternate embodiment of the present invention.

FIG. 3 is a drawing of additional alternate embodiment of the present invention.

FIG. 4 through 27 are drawings of the present invention during a simulated game.

### DESCRIPTION OF THE PREFERRED EMBODIMENT

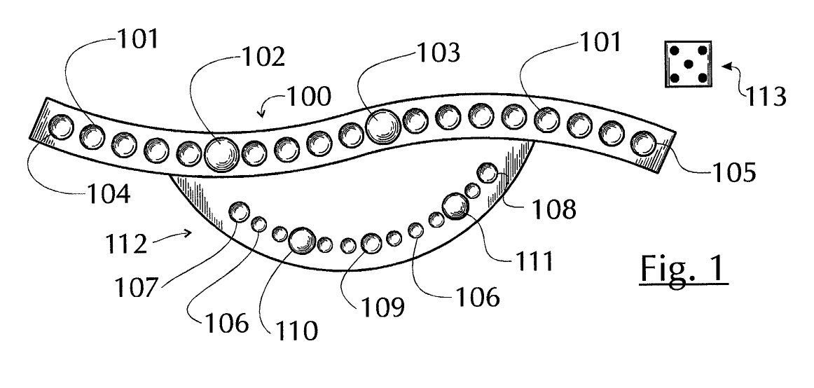

With reference now to the drawings, and in particular to FIGS. 1 through 27 thereof, a new Gambling Game embodying the principles and concepts of the present invention will be described.

As best illustrated in FIG. 1, the present invention comprises a path 100 of play having a plurality of spaces 101 disposed thereon, two game pieces 102 and 103 representing each player. Starting positions 104 and 105 for player's game pieces 102 and 103. A six-sided die 113, wherein each of the sides has a different indicia thereon indicating a number 1 through 6. A score path 112 having a plurality of spaces 106 disposed thereon, two score markers 110 and 111 representing each player's score for movement along the score path 112. Starting positions 107 and 108 for player's score markers 110 and 111. A winning space 109 on the score path 112.

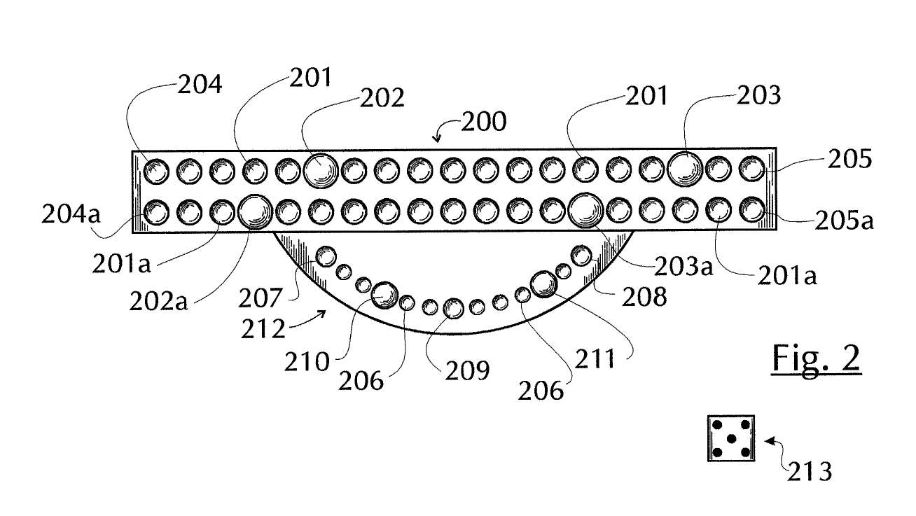

FIG. 2 is a drawing of an alternate embodiment of the present invention comprising two parallel paths 200 of play having a plurality of spaces 201 and 201a disposed thereon, four game pieces 202, 202a, 203 and 203a representing the players. Starting positions 204, 204a, 205 and 205a for player's game pieces 202, 202a, 203 and 203a. A six-sided die 213, wherein each of the sides has a different indicia thereon indicating a number 1 through 6. A score path 212 having a plurality of spaces 206 disposed thereon, two score markers 210 and 211 representing each player's score. Starting positions 207 and 208 for player's score markers 210 and 211. A winning space 209 on the score path 212.

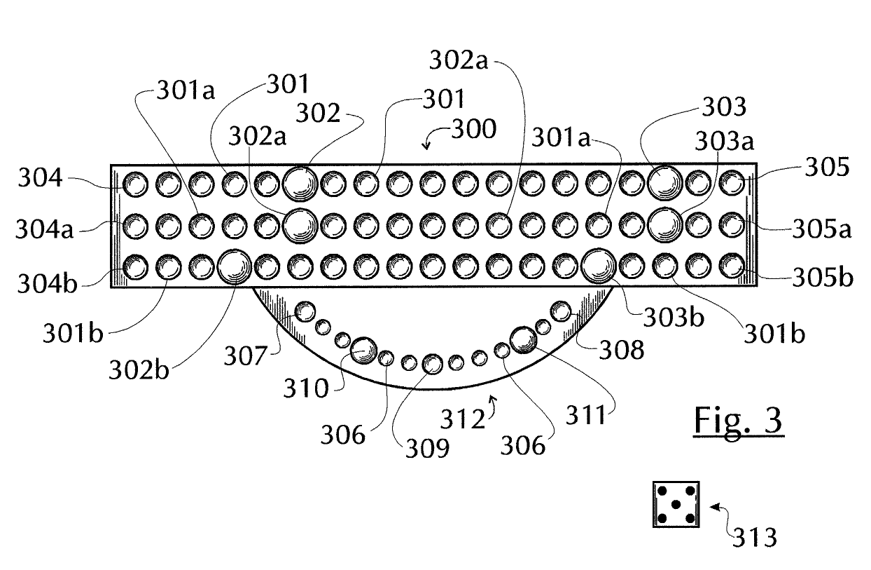

FIG. 3 is a drawing of an additional alternate embodiment of the present invention comprising three parallel paths 300 of play having a plurality of spaces 301, 301a and 301b disposed thereon, six game pieces 302, 302a, 302b, 303, 303a and 303b representing the players. Starting positions 304, 304a, 304b, 305, 305a and 305b for player's game pieces 302, 302a, 302b, 303 303a and 303b. A six-sided die 313, wherein each of the sides has a different indicia thereon indicating a number 1 through 6. A score path 312 having a plurality of spaces 306 disposed thereon, two score markers 310 and 311 representing each player's score. Starting positions 307 and 308 for player's score markers 310 and 311. A winning space 309 on the score path 312.

FIGS. 4 through 27, in accordance to FIG. 1, illustrates the movement of game pieces 102 and 103 along the game path 100 and the movement of score markers 110 and 111 along the score path 112 during a simulated game. Players are identified as Player “A” and Player “B”.

FIG. 4 is a drawing of the start of a game whereas the positioning of game pieces 102 and 103 are disposed thereon the path ends 104 and 105 of the path 100 and score markers 110 and 111 disposed thereon the score start spaces 107 and 108 of the score path 112.

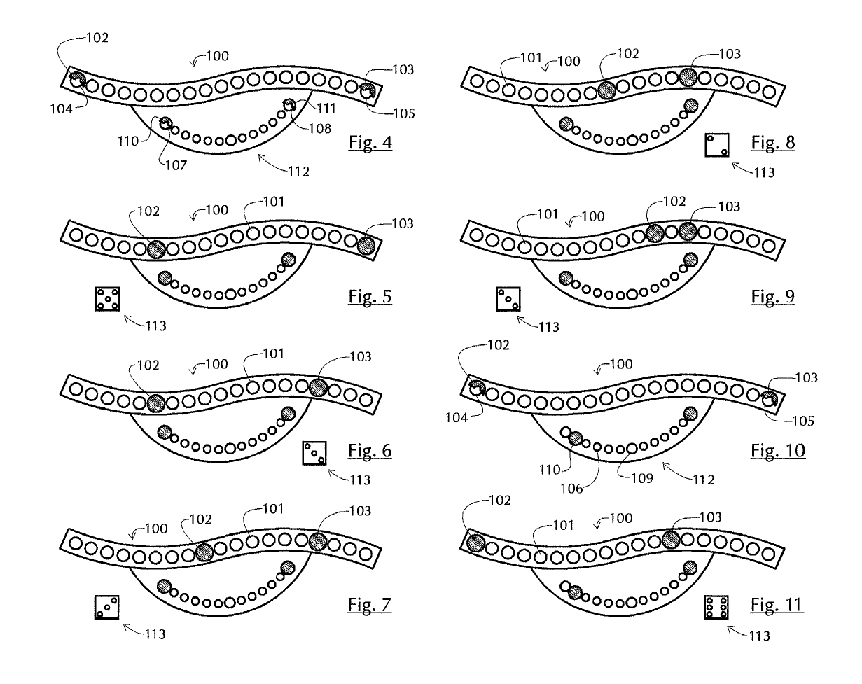

FIG. 5 is a drawing of a die 113 depicting the number five (5) after being rolled by player A and moving its game piece 102, toward player's B game piece 103, the number of spaces 101 along the path of play 100, the number of spaces 101 moved being equal to the number rolled on the die 113.

FIG. 6 is a drawing of a die 113 depicting the number three (3) after being rolled by Player B and moving its game piece 103, toward Player's A game piece 102, the number of spaces 101 along the path of play 100, the number of spaces 101 moved being equal to the number rolled on the die 113.

FIG. 7 is a drawing of a die 113 depicting the number three (3) after being rolled by Player A and moving its game piece 102, toward Player's B game piece 103, the number of spaces 101 along the path of play 100, the number of spaces 101 moved being equal to the number rolled on the die 113.

FIG. 8 is a drawing of a die 113 depicting the number two (2) after being rolled by Player B and moving its game piece 103, toward Player's A game piece 102, the number of spaces 101 along the path of play 100, the number of spaces 101 moved being equal to the number rolled on the die 113.

FIG. 9 is a drawing of a die 113 depicting the number three (3) after being rolled by Player A and moving its game piece 102, toward Player's B game piece 103, the number of spaces 101 along the path of play 100, the number of spaces 101 moved being equal to the number rolled on the die 113.

FIG. 10 is a drawing of repositioning of game pieces 102 and 103 back to the starting positions 104 and 105 after Player B forfeiting to avoid landing on or going over Player's A game piece 102 on its next roll of the die 113. Player A moving its score marker 110 one space 106 toward winning space 109.

FIG. 11 is a drawing of a die 113 depicting the number six (6) after being rolled by Player B and moving its game piece 103, toward Player's A game piece 102, the number of spaces 101 along the path of play 100, the number of spaces 101 moved being equal to the number rolled on the die 113.

FIG. 12 is a drawing of a die 113 depicting the number five (5) after being rolled by Player A and moving its game piece 102, toward Player's B game piece 103, the number of spaces 101 along the path of play 100, the number of spaces 101 moved being equal to the number rolled on the die 113.

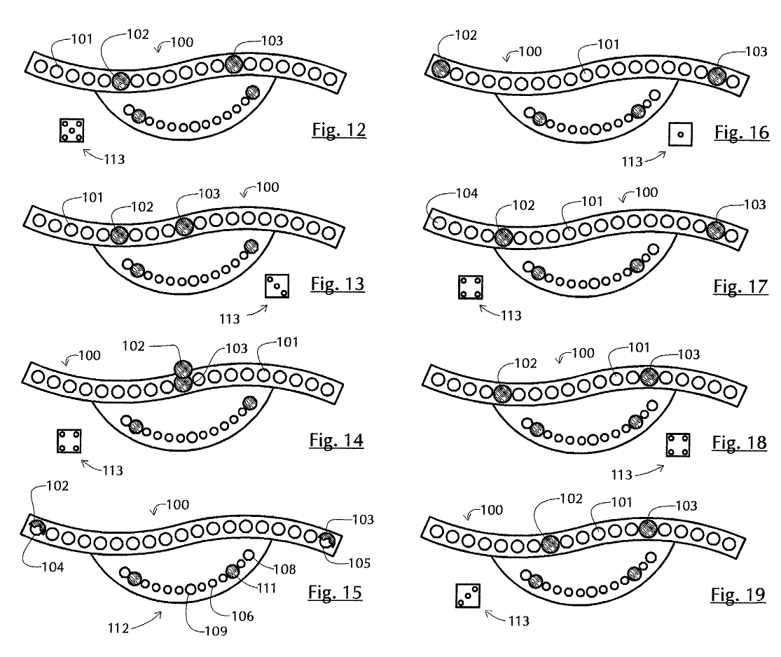

FIG. 13 is a drawing of a die 113 depicting the number three (3) after being rolled by Player B and moving its game piece 103, toward Player's A game piece 102, the number of spaces 101 along the path of play 100, the number of spaces 101 moved being equal to the number rolled on the die 113.

FIG. 14 is a drawing of a die 113 depicting the number four (4) after being rolled by Player A and moving its game piece 102 towards Player's B game piece 103 the number of spaces 101 along the path of play 100, the number of spaces 101 moved being equal to the number rolled on the die 113 resulting in player's A game piece 102 landing on player's B game piece 103.

FIG. 15 is a drawing of repositioning of game pieces 102 and 103 back to the starting positions 104 and 105 after Player's A game piece 102 landed on Player's B game piece 103. Player B moving its score marker 111 two spaces 106 toward the winning space 109.

FIG. 16 is a drawing of a die 113 depicting the number one (1) after being rolled by Player B and moving its game piece 103, toward Player's A game piece 102, the number of spaces 101 along the path of play 100, the number of spaces 101 moved being equal to the number rolled on the die 113.

FIG. 17 is a drawing of a die 113 depicting the number four (4) after being rolled by Player A and moving its game piece 102, toward Player's B game piece 103, the number of spaces 101 along the path of play 100, the number of spaces 101 moved being equal to the number rolled on the die 113.

FIG. 18 is a drawing of a die 113 depicting the number four (4) after being rolled by Player B and moving its game piece 103, toward Player's A game piece 102, the number of spaces 101 along the path of play 100, the number of spaces 101 moved being equal to the number rolled on the die 113.

FIG. 19 is a drawing of a die 113 depicting the number three (3) after being rolled by Player A and moving its game piece 102, toward Player's B game piece 103, the number of spaces 101 along the path of play 100, the number of spaces 101 moved being equal to the number rolled on the die 113.

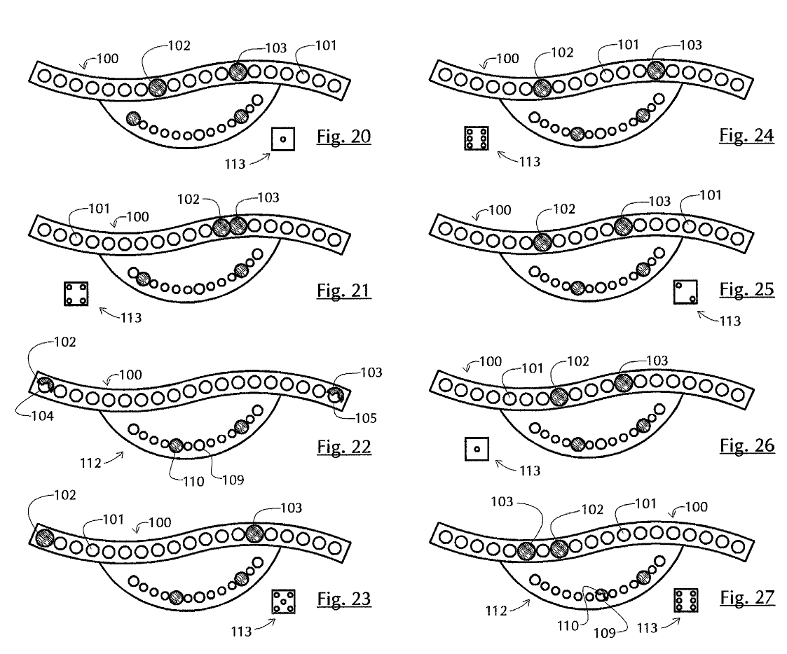

FIG. 20 is a drawing of a die 113 depicting the number one (1) after being rolled by Player B and moving its game piece 102, toward Player's A game piece 103, the number of spaces 101 along the path of play 100, the number of spaces 101 moved being equal to the number rolled on the die 113.

FIG. 21 is a drawing of a die 113 depicting the number four (4) after being rolled by Player B and moving its game piece 103, toward Player's A game piece 102, the number of spaces 101 along the path of play 100, the number of spaces 101 moved being equal to the number rolled on the die 113 resulting in player's A game piece 102 landing in the anterior adjacent space of opponent's game piece 103.

FIG. 22 is a drawing of repositioning of game pieces 102 and 103 back to the starting positions 104 and 105. Player A moving its score marker 110 two spaces 106 toward the winning space 109.

FIG. 23 is a drawing of a die 113 depicting the number five (5) after being rolled by Player B and moving its game piece 103, toward Player's A game piece 102, the number of spaces 101 along the path of play 100, the number of spaces 101 moved being equal to the number rolled on the die 113.

FIG. 24 is a drawing of a die 113 depicting the number six (6) after being rolled by Player A and moving its game piece 102, toward Player's B game piece 103, the number of spaces 101 along the path of play 100, the number of spaces 101 moved being equal to the number rolled on the die 113.

FIG. 25 is a drawing of a die 113 depicting the number two (2) after being rolled by Player B and moving its game piece 103, toward Player's A game piece 102, the number of spaces 101 along the path of play 100, the number of spaces 101 moved being equal to the number rolled on the die 113.

FIG. 26 is a drawing of a die 113 depicting the number one (1) after being rolled by Player A and moving its game piece 102, toward Player's B game piece 103, the number of spaces 101 along the path of play 100, the number of spaces 101 moved being equal to the number rolled on the die 113.

FIG. 27 is a drawing of a die 113 depicting the number six (6) after being rolled by Player B and moving its game piece 103 toward Player's A game piece 102 the number of spaces 101 along the path of play 100, the number of spaces 101 moved being equal to the number rolled on the die 113 resulting in Player's B game piece 103 landing beyond Player's A game piece 102. Player A moving its score marker 110 two spaces 106 and landing onto the winning space 109. Player A is the winner of the game.

### What is claimed is:

1. A method and apparatus for playing a game of chance and odds, comprising of:
a. providing a playing path, said path having a first and second end and being divided into a plurality of spaces for indicating the movement of player's game pieces;
b. having a six-sided die, wherein each of the sides has a different indicia thereon indicating a number 1 through 6;
c. game pieces representing each player;
d. a score path which upon score markers move along to identify points awarded to players;
e. score markers representing each player score;
f. a point value for each way of scoring. One point is given to a player if opponent forfeits. Two points are given to a player if opponent lands on or goes beyond the player's piece. Three points are given to a player that lands in the anterior adjacent space of opponent's game piece; and
g. repeating the following steps until a winner is determined:
I. positioning game pieces and score markers in appropriate starting places;
II. choosing a player to begin by any means;
III. having a player roll the die;
IV. allowing player to move its game piece toward opponent the number of spaces along the path of play, the number of spaces moved being equal to the number rolled on the die;
V. having opponent roll the die;
VI. allowing opponent to move its game piece toward the opposition the number of spaces along the path of play, the number of spaces moved being equal to the number rolled on the die;
VII. allowing player and opponent to continue to alternate turns of rolling the die and moving accordingly until a player or opponent forfeits or lands on opposition's game piece or lands beyond oppositions game piece or until player or opponent's game piece lands in the anterior adjacent space of oppositions game piece;
VIII. allowing player or opponent to move its score marker the amount equal to the amount of points acquired as stated in claim: “1f”.
IX. allowing player and opponent to move its game pieces back to the starting position and repeat game play.

2. The method of playing a game as in claim 1, with an alternate means for indicating the amount of spaces for players to move its game pieces. One means may be a spinner where upon a plurality of spaces, wherein each space has different indicia thereon indicating a number.

3. The method of playing a game as in claim 1, with an alternate embodiment, having adjacent parallel paths, each player being represented by two (2) game pieces.

4. The method of playing a game as in claim 1, with an alternate embodiment, having a plurality of paths, each player being represented by game pieces equal to the amount of paths.

5. The method of playing a game as in claim 1, with an alternate embodiment, having plurality of paths for a plurality of players.
